(19) United States
(12) Patent Application Publication
(10) Pub. No.: US 2015/0108303 A1
(43) Pub. Date: Apr. 23, 2015

(54) ADAPTABLE U-SHAPED BRACKET ASSEMBLIES FOR A LOAD STOP PALLET RACK SYSTEM

(71) Applicant: ROBERT M. CONSAUL, SAN CARLOS, CA (US)

(72) Inventor: ROBERT M. CONSAUL, SAN CARLOS, CA (US)

(21) Appl. No.: 14/549,533

(22) Filed: Nov. 20, 2014

Related U.S. Application Data
(62) Division of application No. 13/844,763, filed on Mar. 15, 2013.

(51) Int. Cl. B65G 1/02

(52) U.S. Cl. CPC B65G 1/026
USPC 248/214

(57) ABSTRACT

The general purpose of the new bracket assembly is to provide a simple, yet versatile and adaptable, mechanism for restricting the movement of loaded pallets on and off pallet racks and within any level of pallet rack bay. In general, the bracket assembly converts a horizontal pallet rack beam into a “load stop” by securing the horizontal beam to the back of the pallet rack such that it prevents damage to walls from otherwise protruding forklifts, pallets and other devices that might be used to load and position pallets onto pallet racks. The new adaptable U-shaped bracket assembly provides a lightweight solution to pallet rack load stops.

### CROSS-REFERENCE TO RELATED APPLICATIONS

This application references U.S. patent application Ser. No. 13/675,346 filed on 13 Nov. 2012, entitled “ADAPTABLE BRACKET ASSEMBLY FOR PALLET RACK LOAD STOP SYSTEM,” and references and claims the benefit of U.S. patent application Ser. No. 13/844,763 filed on 15 Mar. 2013, entitled “ADAPTABLE AND LOCKING BRACKET ASSEMBLIES FOR A LOAD STOP AND LOAD LOCK PALLET RACK SYSTEM,” the disclosure of which is hereby incorporated by reference.

### BACKGROUND

The general purpose of the new adaptable and lockable bracket assemblies is to provide a pallet rack load stop and lock system wherein a novel bracket combines with existing beams to easily create a load stop or lock for use on all storage levels of pallet racks, including at floor-level. There are countless embodiments of the bracket assembly, several of which are herein described and others of which were described in U.S. patent application Ser. No. 13/675,346, but each can be used as either a load stop or a load lock adapter or both. The load stop system prevents damage to walls or inappropriate placement during movement of pallets onto or off of pallet racks. The load locking system prevents unwanted removal of pallets and, thus, pallet rack materials, from storage on or under a pallet rack. The general pallet rack bracket assembly is an adapter bracket made of welded steel with lock-in-place connector pins (a “clip-on” model) or bolt outlets similar to the pins (a “bolt-on” model) and existing pallet rack vertical and horizontal beams with attachment means complimentary to those of the bracket assembly.

This bracket assembly allows for universal use with a variety of pallet rack styles found in hundreds of thousands of existing warehouse facilities. The new adapter presents to manufacturers of pallet racks a low-cost option for creating a physical barrier to removal of pallets and pallet material or a barrier to over-positioning of pallets on racks, as it can be fabricated by repurposing new, leftover, and recycled partially damaged vertical pallet rack beams. Further, the new adapter is compact and easy to stock in supply houses making it readily available for customer acquisition.

The bracket assembly for pallet rack load stopping or locking is designed to connect to pallet rack vertical beams via the same mechanisms as existing pre-engineered horizontal beams, thus making the device highly adaptable and easy to use with existing materials. Since pallet racks can be engineered with different compositions and thicknesses of metal and any of several different types of connectors, the new adaptable bracket assembly can be engineered to compliment any type of pallet rack system.

Descriptions of pallet rack systems commonly reference “beam locking devices.” Though these devices sound as though they are designed or able to be used for securing pallets within pallet bays, they are, however, generally referencing devices for securing horizontal beams to vertical beams in pallet rack construction where the reference “horizontal beams” are actually the beams used to support pallets while housed within a pallet rack system. These prior art crossbeams are designed to be installed once—at the time of construction—and to bear the weight of the pallets and pallet contents. They are not designed to be removed and replaced at will and generally do not have any type of discretionary locking means, and, thus, they cannot be used as pallet rack load locks.

Another commercially available product for securing pallet contents is an “entire cover system,” which likens to a portable storage unit. These systems are expensive and impractical to implement in small or large warehouse settings, and the substantially increased surface area of such systems makes them wholly undesirable in food warehouses due to increased likelihood and difficulty in sterilizing of biological contaminations. The new bracket assembly enables a superior and simpler locking system that does not pose these challenges.

### SUMMARY

The general purpose of the new bracket assembly is to provide a simple, yet versatile and adaptable, mechanism for restricting the movement of loaded pallets on and off pallet racks and within any level of pallet rack bay. In general, the bracket assembly converts a horizontal pallet rack beam into a “load stop” by securing the horizontal beam to the back of the pallet rack such that it prevents damage to walls from otherwise protruding forklifts, pallets and other devices that might be used to load and position pallets onto pallet racks. The “load lock” function of the bracket assemblies converts the load stop into a pallet removal prevention tool by enabling a horizontal beam to attached and lock to the front of a pallet rack.

### BRIEF DESCRIPTION OF THE DRAWINGS

FIGS. 1A-1E collectively depict a U-shaped embodiment of the bracket assembly. This U-shaped bracket assembly can be mounted from the side instead of the front and, thus, is better suited for use on closed-back pallet rack vertical beams.

### DETAILED DESCRIPTION

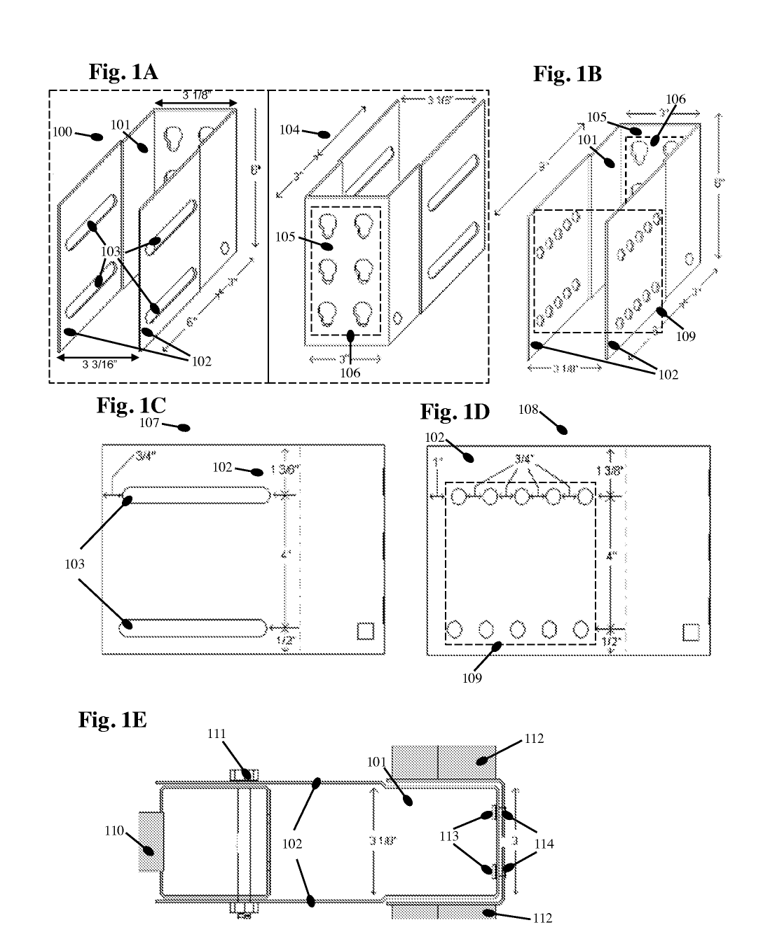

FIGS. 1A-1E depicts a U-shaped embodiment of the bracket assembly. This U-shaped bracket assembly can be mounted to an inner side of a vertical pallet rack beam as opposed to the outer side and, thus, is better suited for use on closed-back pallet rack vertical beams. Whether mounted to an outer side or an inner side of a vertical beam, this U-shaped embodiment is adjustable, allowing for three to nine inches of desired clearance.

In terms of production value, this model does not require welding and is less costly to produce than most other embodiments. Some pallet racks do not have an open back so the front bolt on will not work for closed back pallet rack vertical beams.

FIG. 1A shows the top-front-side view 100 and the top-back-side view 104 of one embodiment of an adjustable U-shaped bracket assembly having bilateral flanges 102 attached to two side plates 101. The flanges each contain two horizontal slots 103 for adjusting clearance as desired. Also shown are six female teardrop connectors 106 in the end plate 105 of the U-shaped bracket assembly.

FIG. 1B shows the top-front-side view of another embodiment of an adjustable U-shaped bracket assembly having bilateral flanges 102 attached to two side plates 101. The flanges each contain two parallel sets of horizontal bolt holes 109. Visible in part are six female teardrop connectors 106 in the end plate 105 of the U-shaped bracket assembly.

FIG. 1C shows the side view of an adjustable U-shaped bracket assembly 100 having upper and lower bolt slots 103 through the visible flange 102 extending from the front, open end of the bracket.

FIG. 1D shows the side view of an adjustable U-shaped bracket assembly 108 having a set of upper and lower bolt holes 109 through the visible flange 102.

FIG. 1E shows the top view of a U-shaped bracket assembly attached by the open end to an existing pallet rack vertical beam 110 via a bolt 111 inserted through the bilateral flanges 102 of the bracket assembly and the existing bolt holes on the sides of the vertical beam and attached by the end plate to two horizontal pallet rack beams 112 via insertion of the three pin connectors 113 of the horizontal beams into the female teardrop connectors 114 of the end plate of the bracket assembly.

1. An adjustable U-shaped bracket assembly for a pallet rack, comprising:
a support means of two vertical, parallel side plates;
a first end means of two vertical, parallel flanges, the inside surface of which is roughly coplanar with and extends from the outer surface of said support means such that the inner distance between the flanges is greater than the distance between the side plates, the flanges being a suitable width apart as to fit neatly against two opposing outer sides of a vertical pallet rack beam and having a plurality of opening means of such quantity, shape and arrangement as suitable for attachment to a horizontal pallet rack beam;
second end means having a plurality of connection members of such quantity, shape and arrangement as suitable for attachment to a horizontal pallet rack beam.

2. An adjustable U-shaped bracket assembly for a pallet rack as described in claim 1, wherein said flanges are created by vertically crimping the support means, having a length intended for the completed bracket assembly, at a horizontal location that is less than the minimum desired clearance.

3. An adjustable U-shaped bracket assembly for a pallet rack as described in claim 1, wherein said flanges are created by welding the edges of two extension means onto the support means.

4. An adjustable U-shaped bracket assembly for a pallet rack as described in claim 1, wherein the opening means of the first end means are horizontal series of discrete holes identically placed in each flange and of a size and spacing that allows for insertion and securing of a bolt through opposing holes in the flanges and simultaneously through opposing holes in the sides of the vertical beam that abut the fitted flanges.

5. An adjustable U-shaped bracket assembly for a pallet rack as described in claim 1, wherein the opening means of the first end means are two horizontal slots identically placed in each flange and of a size and spacing that allows for insertion and securing of a bolt through opposing slots in the flanges and simultaneously through opposing holes in the sides of the vertical beam that abut the fitted flanges.
